(19) United States
(12) Patent Application Publication
(10) Pub. No.: US 2004/0218924 A1
(43) Pub. Date: Nov. 4, 2004

(54) Optical communications system and method for transmittin point-to-point and broadcast signals

(76) Inventor: Habib Fathallah, Sainte-Foy (CA)

Correspondence Address: Baker & Hostetler, Washington Square Suite 1100, 1050 Connecticut Avenue NW, Washington, DC, 20036, US

(21) Appl. No.: 10/476,446

(22) PCT Filed: May 1, 2002
(86) PCT No.: PCT/CA02/00647

Related U.S. Application Data
(60) Provisional application No. 60/287,371, filed on May 1, 2001.

(51) Int. Cl. H04J 4/00

(52) U.S. Cl. 398/77

(57) ABSTRACT

A system and method for the simultaneous transmission of point-to-point and broadcast signals over an optical network are provided. In accordance with this invention, the user terminals of the system are divided into groups of user terminals, each assigned a different waveband. Each user terminal within one group is assigned a different point-to-point code within its corresponding waveband for encoding and decoding point-to-point signals exchanged with the central office. A signal broadcast code is assigned per groups of users and therefore per wavebands, for all of the users of a same group to use. All signals on all wavebands are transmitted through the network, but each user terminal may only access point-to-point signals addressed to himself and a copy of the broadcast signal.

### FIELD OF THE INVENTION

The present invention relates to optical communications and more particularly concerns a system and method for simultaneously sending point-to- point and broadcast signals over a network.

### BACKGROUND OF THE INVENTION

Fiber-to-the-curb and fiber-to-the-home applications are an important step for the successful deployment of all-optical communications systems. In these applications, the capacity to accommodate two different type of services, broadcast and point-to-point transmissions, is key for a solution to be promising. point-to-point signals are exchanged between the central office and each user of the system independently, and each should be accessible only to the particular user it is addressed to. Broadcast transmissions, such as a radio or television signals, should indiscriminately be accessible by all users of the system. It is mandatory for a solution to allow ultimate security for the point to point links while allowing real transparency of broadcast services for all users. User requirements in these networks is challenging because of the nature diversity of the services. Very few approaches exist for fiber optic based infrastructure; most of them are limited by the number of users (or subscribers) that could achieve profitability for the service provider.

FIG. 1 (PRIOR ART) shows an architecture from Lucent Technology allowing the simultaneous transmission of point-to-point (PTP) and broadcast (BR) services. PTP transmission is allowed using wavelength division multiplexing (WDM) technology, where each user is assigned one wavelength channel. The broadcast signal is carried using a broadband signal generated by a LED, and externally modulated by the BR signal. In proximity of the users, an array of waveguide gratings (AWG) multiplexer/demultiplexer splits the total signal into sub-bands, each of which is dedicated to a different user. Each user receives its addressed data through its proper wavelength and a copy of the broadcast signal through the split band of the broadband signal. Electronic processing is usually necessary in order to extract the content of each signal.

The above prior art system however presents several drawbacks. The number of wavelengths that could be carried in a standard frequency band is very limited, especially when low channel count (sparse) multiplexers/demultiplexers are used. Using denser multiplexers/de-multiplexers would however dramatically increase the overall cost of the system. In addition, separate wavelengths for point to point links do not provide any privacy and security to channels. This becomes critical especially in access areas.

OCDM (optical code division multiplexing) is a promising broadcast and select architecture for point-to-point transmissions. Each user receives the sum of all transmitted signals, but however has the authorisation to read only messages carried by his own code. Even if the entire signal is sent to all users, all the information it carries is not accessible by all of them. The OCDM architecture is however generally applied to point-to-point systems. It prevents the delivery of broadcast-nature services like a television signal unless it is electronically added to each PTP link. This is however complex and cumbersome.

### OBJECTS AND SUMMARY OF THE INVENTION

It is therefore an object of the invention to provide an optical communications method and system for jointly transmitting point-to-point and broadcast signals over a network.

It is a preferable object of the present invention to provide such a method and system that alleviates the above mentioned drawbacks of the prior art.

Accordingly, the present invention provides a method for enabling an exchange of information over an optical network connecting a central office and a plurality of user terminals. The exchanged information includes point-to-point signals exchangeable between the central office and each of the user terminals, and a broadcast signal transmittable from the central office to all of the user terminals. The method includes the following steps:

a) dividing the plurality of user terminals into groups of user terminals;

b) assigning a different spectral waveband to each of these groups;

c) for each group of user terminals, performing the substeps of:

i) assigning a different point-to-point code within the corresponding waveband to each user terminal of this group, for encoding and decoding therewith point-to-point signals exchanged between the central office and the user terminal; and

ii) assigning a same broadcast code within the corresponding waveband to all user terminals of the same group, for encoding and decoding therewith the broadcast signal sent by the central office to each user terminal of this group; and

c) enabling the transmission of all wavebands from the central office to the user terminals through the optical network.

In accordance with another aspect of the present invention, there is also provided a method for exchanging information over an optical network connecting a central office and a plurality of user terminals, this information including point-to-point signals exchanged between the central office and each of the user terminals and a broadcast signal sent from the central office to all of the user terminals. The method includes the steps of:

a) dividing the user terminals into groups of user terminals;

b) assigning a different spectral waveband to each of these groups;

c) encoding point-to-point signals to user terminals of each group within the corresponding waveband, each of the point-to-point signals being decodable by only one user terminal;

d) encoding a copy of the broadcast signal within the corresponding waveband of each group, each copy of the broadcast signal being decodable by all user terminals of the corresponding group; and

e) transmitting the point-to-point signals and copies of the broadcast signal in all wavebands from the central office to the user terminals through the optical network.

The present invention also provides an optical communications system for exchanging information over an optical network between a central office and a plurality of users. The information including point-to-point signals exchanged between the central office and each of the users, and a broadcast signal sent from the central office to all of the users.

The system includes a plurality of user terminals associated with the plurality of users. The user terminals are divided into groups of user terminals, and a different spectral waveband is assigned to each of these groups.

The system also includes a central office transmitter provided at the central office. The central office transmitter includes point-to-point encoding means for encoding point-to-point signals using point-to-point codes, different point-to-point codes within a same corresponding waveband being associated to the user terminals of a same group. Broadcast encoding means are also provided, for encoding copies of the broadcast signal using broadcast codes within the corresponding waveband of each group, a single broadcast code being associated with all the user terminals of a same group. The central office transmitter finally includes transmitting means for transmitting the point-to-point signals and copies of the broadcast signal in all wavebands from the central office to the user terminals through the optical network; and

The communications system of the present invention also includes a user receiver provided at each user terminal, for receiving from the optical network the point-to-point signals and copies of the broadcast signal. Each user receiver includes point-to-point decoding means for decoding point-to-point signals encoded using a point-to-point code associated with the corresponding user terminal, and broadcast decoding means for decoding the broadcast signal decodable using the broadcast code associated with the user terminals of the corresponding group of user terminals.

Other features and advantage of the present invention will be better understood upon reading of preferred embodiments thereof with reference to the appended drawings.

### BRIEF DESCRIPTION OF THE DRAWINGS

FIG. 1 (PRIOR ART) shows an optical communications system according to prior art allowing the simultaneous transmission of point-to-point and broadcast signals.

FIGS. 2A, 2B and 2C illustrate the encoding of point-to-point and broadcast signals according to respectively a first, a second and a third embodiment of the present invention.

FIGS. 3A illustrate an optical communications system according to the embodiment of FIG. 2A. FIGS. 3B and 3C show variants to the system of FIG. 3A in accordance with the embodiments of FIGS. 2B and 2C, respectively.

FIG. 4 shows an encoding device for use with a preferred embodiment of the present invention.

FIG. 5 shows a communications system implementing the encoding device of FIG. 4.

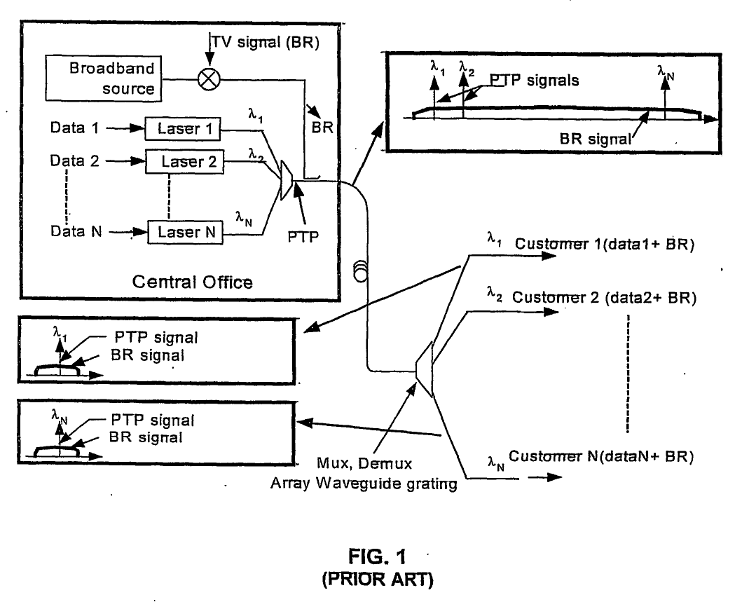

### DESCRIPTION OF PREFERRED EMBODIMENTS OF THE INVENTION

In accordance with a first aspect of the present invention, there is provided a method for enabling the exchange of both point-to-point and broadcast information over an optical network. The optical network is preferably optical fiber-based. It is understood the network connects a central office and a plurality of user terminals, each terminal being associated to at least one user. By “point-to-point signals” it is meant transmissions exchangeable between the central office and each of the user terminals individually, and by “broadcast signals” it is meant general transmissions sent from the central office to all of the user terminals, such as a radio or television station, etc. Point-to-point therefore are two-ways, that is that both the central office and the user terminal involve sent and receive information, whereas broadcast transmissions generally involve only a transmitter at the central office and a receiver at each user terminal.

The first step of the present method consists in dividing the user terminals into separate groups, each including a predetermined number of user terminals. For example, in a preferred embodiment each group includes between 2 and 30 user terminals. A different spectral waveband is then assigned to each of these groups. By “waveband” or “wavelength band” it is meant an appropriate portion of the spectrum usable for optical telecommunications, this spectrum being preferably embodied by, but not limited to, standard C, L, or S fiber bands or combinations thereof. Each waveband preferably has a spectral width of about 0.4 to 8 nm, depending on the needs of the encoding scheme used as will be explained further below.

Still in accordance with the present method, within each group of user terminals a different point-to-point code is assigned to each user terminal, this code using strictly the corresponding waveband assigned to this group. The point- to-point codes will be used for encoding and decoding all point-to-point signals exchanged between the central office and the corresponding user terminal. A broadcast code within the corresponding waveband is also provided, but in this case, the same broadcast code is assigned to all user terminals of a same group, for encoding and decoding therewith the broadcast signal sent by the central office to each user terminal of this group. The transmission of all signals in all wavebands of the spectrum is then enabled between the central office and all of the user terminals through the optical network. In this manner, every user terminal receives all of the information transmitted by the central office, but is only able to access from it the point-to-point signals which are specifically addressed thereto and a copy of the broadcast signal.

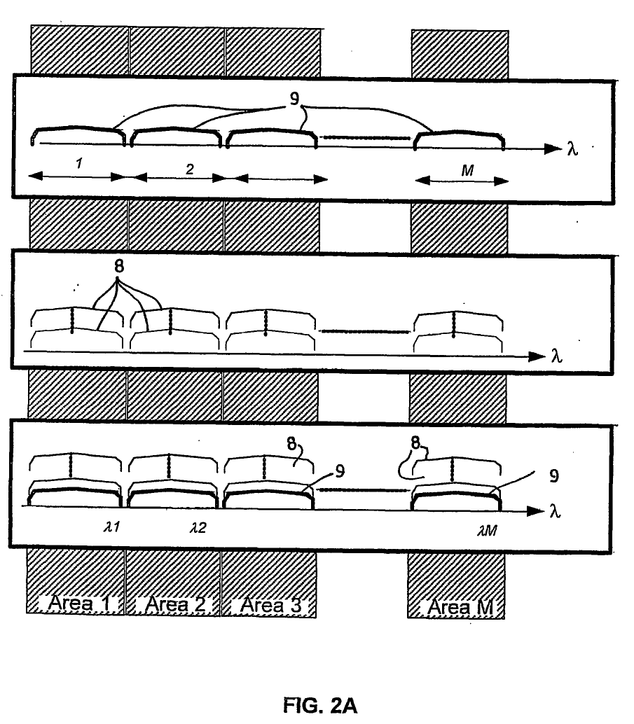

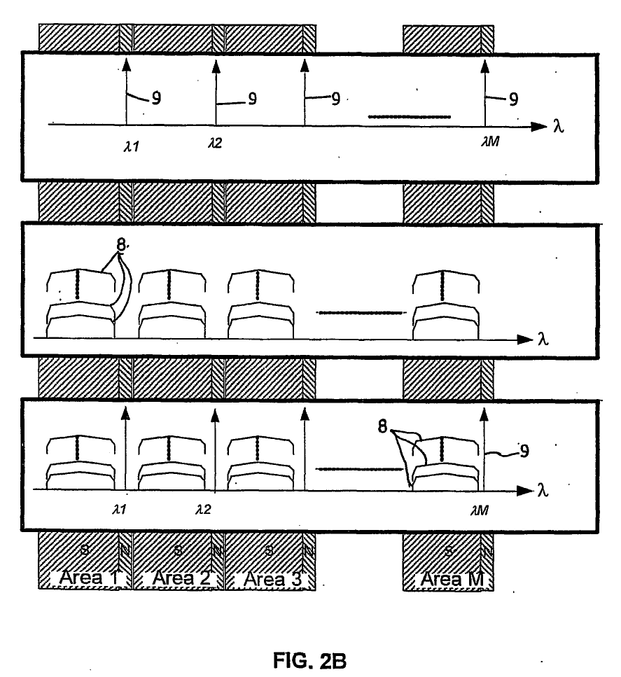

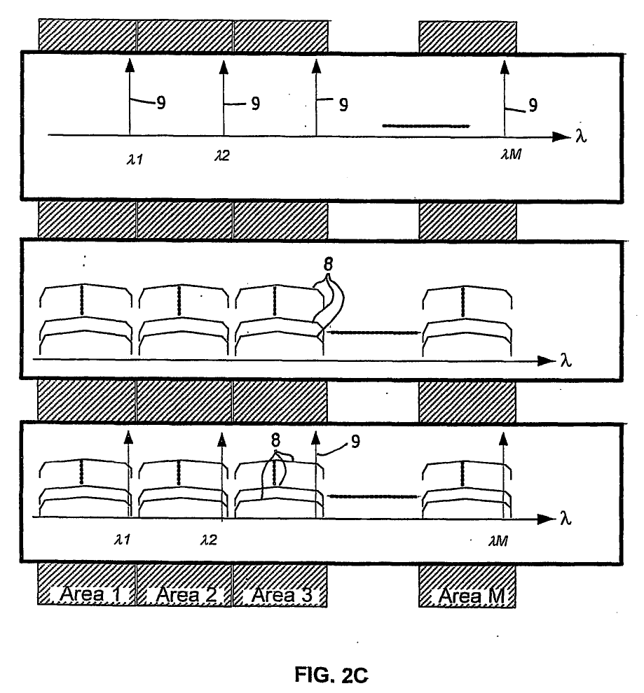

Referring to FIG. 2A, there is shown a first exemplary application of the present method. As may be seen, the spectrum (represented by the horizontal axis) is divided in M wavebands (area1, area2, area3, . . . , areaM), which in the present case are all the same width and are evenly spaced. The middle graph shows the encoding of the point-to-point signals 8 to all the users, each with a different point-to-point code using the whole corresponding waveband. Preferably, each point-to-point signal 8 is encoded using an OCDM-type encoding scheme, where a given modulated signal is separated in a number of wavelength peaks with the corresponding waveband, which are delayed with respect to each other in accordance with a given predetermined code. Such a “slice and delay” scheme, also called Frequency Hopping (FH), is for example shown in H. Fathallah, “Fast frequency hopping spread spectrum for code division multiple access communications networks,” U.S. Ser. No. 09/192,180 and Canada no. 2,249,877). The present invention could also be applied to other encoding schemes such as “spectrum slicing”, also called Frequency Encoding (FE), as shown for example in T.Pfeiffer et al., Electronics Letters, vol.33, no.25, pp.2141-2142, 1997).

In the embodiment of FIG. 2A, a copy 9 of the broadcast signal is also encoded within each waveband using an OCDM code, as shown in the top graph. The broadcast OCDM code should be different from the point-to-point OCDM code, and the waveband should therefore be able to support a total of M+1 different codes. As shown in the bottom graph, the transmitted signal is a sum within each waveband of all the signals from the top and middle graphs. Each user terminal however has the capacity to decode only the point-to-point signals encoded using its own personal point-to-point code and the copy of the broadcast signal encoded using the broadcast code of the group it belongs to.

Referring to FIGS. 2B and 2C, there are shown alternative embodiments of the present invention where each copy 9 of the broadcast signal is encoded within a wavelength channel λ₁, λ₂, λ_{M}, included within the corresponding waveband. It will be noted that WDM technology may advantageously be used in this case for the broadcast signal only, as such signals are not the subject of any privacy concerns.

In the embodiments of FIG. 2B, each waveband is further divided into two sub-wavebands S and N. The first sub-waveband S covers preferably a large portion of the corresponding waveband, and is used for the encoding of the point- to-point signals using OCDM codes. The second sub-waveband N should be large enough to provide the wavelength channel used to encode the broadcast signal. In this manner, there is a true spectral separation between the two signals receivable by a given user terminal.

In the embodiment of FIG. 2C, the wavelength channel carrying the broadcast signal overlaps the point-to-point signals which are preferably encoded using the whole waveband. The separation between the point-to-point and broadcast signals is therefore virtual, and appropriate measures to differentiate them upon decoding should be provided.

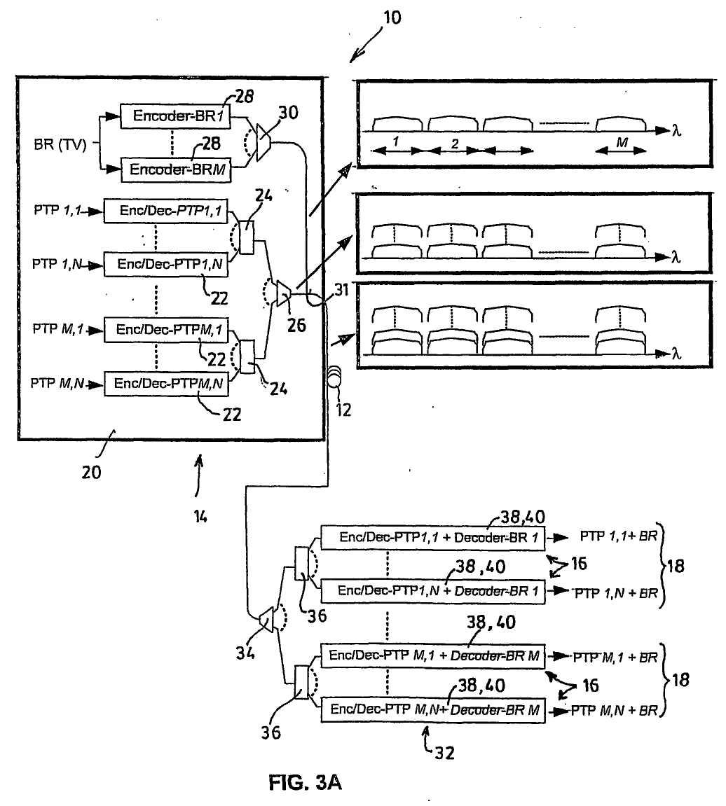

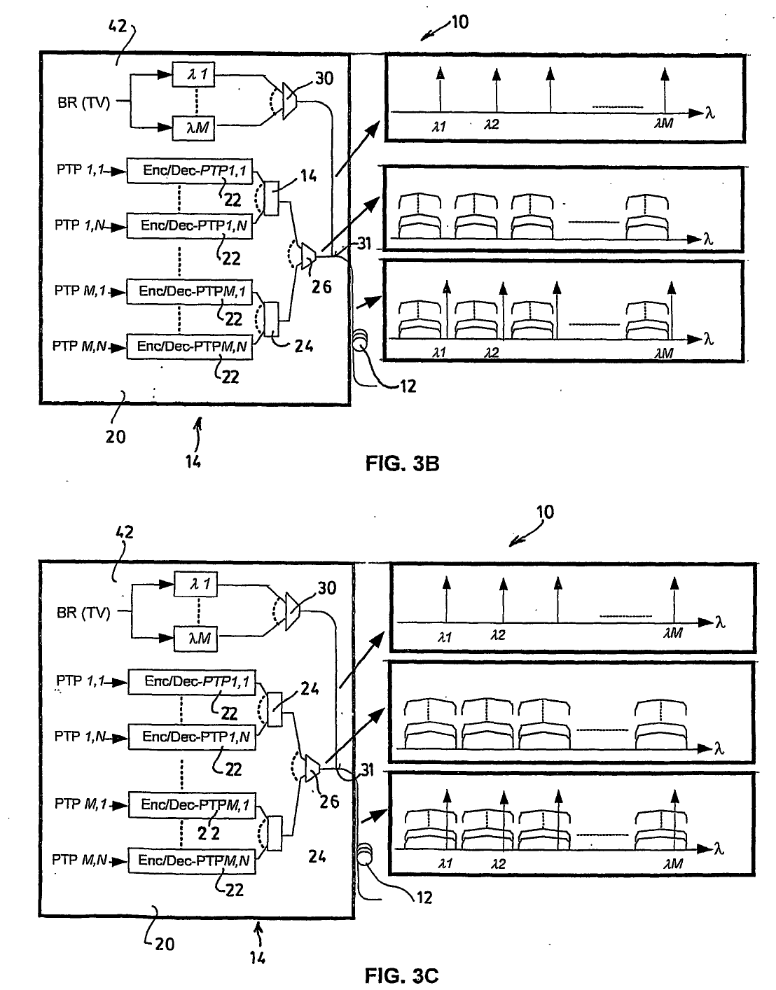

Referring to FIGS. 3A, 3B, 3C, 4 and 5, and in accordance with another aspect of the present invention, there is also provided an optical communications system 10 for exchanging information over an optical network 12, between a central office 14 and a plurality of users. The “information” includes point-to-point signals exchanged between the central office and each of the users and a broadcast signal sent from the central office to all of the users, as explained above.

Referring more particularly to FIG. 3A, there is shown a first preferred embodiment of the system 10 of the present invention, using the method illustrated in FIG. 2A. The system includes a plurality of user terminals 16, associated with the plurality of users. These user terminals 16 are divided into groups 18 of user terminals, and a different spectral waveband is assigned to each of these groups. At the central office 14, a central office transmitter 20 is provided. It includes point- to-point encoding means, preferably embodied by a plurality of point-to-point encoders 22 each associated with one of the user terminals 16 and using a different point-to-point code, preferably embodied by OCDM codes. Point-to-point codes associated to user terminals of a same group 18 all use the corresponding waveband associated with this group 18. Although the principles of the present invention are particularly advantageous for allowing the transmission signals from the central office to the user terminals, it will be well understood by one skilled in the art that in practical applications the system of the present invention will preferably allow the transmission of point-to-point signals from the user terminals back to the central office. For this purpose, the point-to-point encoders 22 are preferably embodied by encoding/decoding devices apt to receive point-to-point signals from the user terminals and decode them using the corresponding point-to- point code. For an example of a particularly advantageous encoding/decoding device for use in the present system, see for example the co-assigned PCT application filed through the Canadian receiving office on Apr. 23, 2002, entitled “Optical encoding/decoding device” (MENIF et al).

The central office transmitter 20 also includes broadcast encoding means for encoding copies of the broadcast signal, preferably embodied by broadcast encoders 28. In this embodiment, which corresponds to the embodiment of FIG. 2A, copies of the broadcast signal are encoded using an OCDM code within each waveband. The broadcast encoders 28 may therefore be similar to the point-to- point encoders 22, with the exception that no decoding capabilities are necessary. A single broadcast encoder is used for each group 18 of user terminals 16, each using a broadcast code within the corresponding waveband of this group 18.

The central office transmitter also includes transmitting means for transmitting the point-to-point signals and copies of the broadcast signal in all wavebands from the central office 14 to all of the user terminals 16 through the optical network 12. In the illustrated embodiment, the point-to-point signals outputted by all the point-to-point encoders 22 of a same group are first combined within a same optical fiber path by a coupler 24, of any type appropriate for combining optical signals of a same waveband. Preferably, the coupler 24 is embodied by a passive splifter/combiner, which combines outgoing signals for transmission to the network 12 and splits incoming signals for distributing portions thereof to the all the encoder/decoders. The combined point-to-point signals from all the different wavebands are then multiplexed using a multiplexer/demultiplexer 26, which is preferably embodied by a passive WDM splifter/combiner. Again, the multiplexer/demultiplexer 26 combines outgoing signals from all wavebands and splits incoming signals into the different wavebands. All the copies of the broadcast signal are also multiplexed by multiplexer 30 and later combined to the point-to-point signals by a coupler 31.

At the each user terminal 16, a user receiver 32 provided for receiving from the optical network the point-to-point signals and copies of the broadcast signal. Preferably in the vicinity of the user terminals a multiplexer/demultiplexer 34 is provided for splitting the incoming signal into the separate wavebands and combining the outgoing signals in all waveband into a same fiber path. within a same group, a passive splitter/combiner 36 splits the signal of the corresponding wavebands into fractions thereof for sending to each user terminal 16, whereas in the other direction it combines all the outgoing signals from the user terminals 16 for transmission to the central office 14.

Each user receiver 32 includes point-to-point decoding means for decoding the point-to-point signals sent to the corresponding user, using the point-to-point code associated with the corresponding user terminal. The decoding means are preferably embodied by an encoder/decoder 38 preferably using an OCDM code. It will be readily understood by one skilled in the art that in the embodiment described herein the encoders and decoders at the central office and the user terminals need to be mirror to each other. In the preferred embodiment, the broadcast signal is also encoded using an OCDM code; there is therefore a need for a second decoder 40 using the appropriate broadcast code associated with the group 18 of terminals 16 the user is associated with.

Referring to FIGS. 3B and 3C, there are shown two alternative embodiments of the invention. In this case, the broadcast encoding means include a comb of equally spaced wavelength channels 42 for including a copy of the broadcast signal within one wavelength channel per waveband. This may for example be generated by a bank of separate lasers, laser arrays or filtered broadband sources. In the preferred embodiments of the invention, a LED followed by an external modulator followed by a series of Bragg gratings are used. In the case of FIG. 3B, the point-to-point encoder 22 only use a sub-waveband of the corresponding waveband and the wavelength channel of the corresponding waveband is chosen in a second sub-waveband, as explained with reference to FIG. 2B. In FIG. 3C, as with FIG. 2C, the wavelength channels are superposed to the point-to-point codes. In these embodiments, different techniques may be used to differentiate the broadcast from the point-to-point signals. The wavelength carrying the broadcast signal may be extracted by a notch filter, optically separated from the point-to-point signals and detected by a separate photodetector. In the embodiment of FIG. 3B, this technique could suffer from the noise coming from the point-to-point codes. In the embodiment of FIG. 3C, the broadcast signal can be detected like a conventional WDM signal. Alternatively, electrical separation may be used. If no optical separation is required between the broadcast and point-to-point signal, both are detected simultaneously using the same photodetector. Otherwise, electrical filtering may be used to extract each signal from the other if they are carried with different electrical carriers.

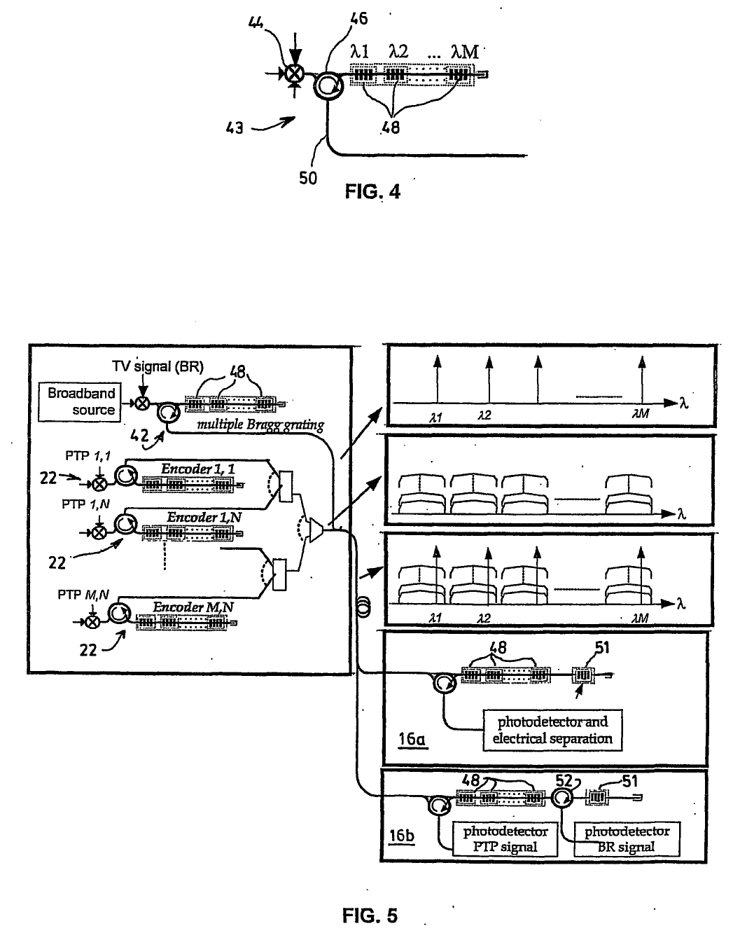

Referring to FIG. 4, there is shown an example of an grating device 43 for use with the system of the present invention. The grating device 43 includes a modulator 44 for modulating the light from a broadband source such as a LED in accordance with the broadcast data, followed by a circulator 46 which redirects the modulated signal to a series of Bragg gratings 48. Each Bragg grating 48 reflects a pre-selected wavelength or small waveband, which goes back through the circulator 46 to be directed towards the output 50.

Referring to FIG. 5, there is shown how the grating device of FIG. 4 may be put to use in the system of the present invention, using the embodiment of FIG. 3B as an example. The grating device is used as the comb of wavelength 42 of the broadcast encoding means by selecting the Bragg gratings 48 so that they each reflect a single wavelength channel, each corresponding to one of the wavebands. The same device may be adapted for use as the point-to-point encoders 22. In this case, The Bragg gratings each reflect a predetermined peak wavelength within the corresponding waveband and the point-to-point codes are generated by varying the order and delay between each peak.

By performing the reverse operation, the same device is used as a decoder, either at the user terminal end or at the central office. In the example of FIG. 5, there are shown two different embodiments of a user terminal using a Bragg grating device as the decoder. In first user terminal 16a, the series of Bragg gratings 48 simply include one grating 51 for the broadcast wavelength channel, the output signal is detected by a single photodetector and the broadcast and point-to-point components are electrically separated. In the second user terminal 16b, a second circulator 52 is positioned between the series of Bragg gratings 48 of the point-to-point decoding and the wavelength channel grating 51, to output the reflected wavelength channel 51 separately.

In summary, the present invention provides a method to architect a fiber optic access network that involves a mix of two different and natures of services: a number of point-to-point services and one broadcast service. The invention proposes the partition of a resource area, here frequency band in a fiber, into a couple of resource segments, one is considered shareable, and. the other is not. The sharable segment carries a mix of a number of point to point services, i.e., a kind of source/destination addressing that is required to differentiate point-to-point links. The non-sharable segment carries the broadcast signal and this is transparent for all users (i.e. the signal in this area could be received from any receiver) or observable by all users (or channels).

Typical fiber resource, (include the standard fiber bands like C, L, S etc.), could be partitioned into a number of resource areas, every resource area could be divided into a couple of segments, as previously defined.

One preferred embodiment suggests the use of OCDM codes such as optical fast frequency hopping CDMA codes to support point-to-point links, and wavelengths to support the broadcast signals. A second suggests the use of optical fast frequency hopping codes for all services; however this involves a modified decoding devices. According to this embodiment, the segmentation (or separation) between sharable and non-sharable resource segments could be virtual instead of physical as this is the case in the first embodiment.

The method of architecting the network invented here, however, covers all forms of spectral OCDM technologies.

The benefits of using optical CDMA links for the point to point services consist of: 1) its ability to maximise the number of channels in a specific resource area, 2) security and privacy of the point-to-point links, and 3) the simple low cost splitter/combiner based architecture. However, the benefit of using wavelengths to carry broadcast signal holds in the commercial availability of wavelength division multiplexers and de-multiplexers.

Of course, numerous modifications could be made to the embodiments described above without departing from the scope of the invention as defined in the appended claims.

1. A method for simultaneously exchanging point-to-point signals and 3 broadcast signal over an optical network connecting a central office and a plurality of user terminals, said point-to-point signals being exchangeable between the central office and each of the user terminals and the broadcast signal being simultaneously transmittable from the central office to all of the user terminals, said method comprising the steps of
a) dividing said user terminals into groups of user terminals:
b) assigning a different spectral waveband to each of said groups;
c) encoding point-to-point signals to user terminals of each group within the corresponding waveband, each of said point-to-point signals being encoded with a predetermined optical code and decodable by only one user terminal;
d) encoding a copy of the broadcast signal within the corresponding waveband of each group, each copy of the broadcast signal being encoded within a single wavelength channel included within said corresponding waveband, said copy of said broadcast signal being decodable by all user terminals of the corresponding group; and
e) transmitting the point-to-point signals and copies of the broadcast signal in all wavebands from the central office to the user terminals through the optical network.

2. The method according to claim 1, wherein the encoding of step c) comprises using OCDM codes.

3. The method according to claim 1, wherein, in each of said wavebands, the single wavelength channel coding said copy of said broadcast signal overlaps the point to point optical codes.

4. The method according to claim 1, comprising an additional step before step c) of dividing each waveband into a first and a second sub-waveband, and wherein:
step c) comprises encoding the point-to-point signals into the first sub-waveband of the corresponding waveband; and:
step d) comprises encoding the copies of the broadcast signal into the second sub-waveband of the corresponding waveband.

5. The method according to claim 4, wherein the encoding of step d) comprises providing each copy of the broadcast signal into a single wavelength channel, said wavelength being included into the second sub-waveband of the corresponding waveband.

6. The method according to claim 1, wherein, in step a) each group of user terminals includes between 2 and 30 user terminals.

7. The method according to claim 1, wherein, in step b), each waveband has a spectral width between 0,4 and 8 nm.

8. The method according to claim 1, wherein step e) comprises the substeps of:
i) multiplexing the point-to-point and broadcast signals of all wavebands into a multiplexed signal propagating a single optical fiber;
ii) propagating said multiplexed signal through the optical network;
iii) in the vicinity of the user terminals, de-multiplexing the multiplexed signal into waveband signals so that each of said waveband signals propagates in a different optical fiber; and
iv) splitting each waveband signal into a number of fractions corresponding to the number of user terminals in the corresponding group and transmitting said fractions to the user terminal of said group.

9. An optical communication system for simultaneously exchanging point-to-point signals and a broadcast signal over an optical network between a central office and a plurality of users, said point-to-point signals being exchangeable between the central office and each of the users and the broadcast signal being simultaneously transmittable from the central office to all of the users, said system comprising:
a plurality of user terminals associated with the plurality of users, said user terminals being divided into groups of user terminals, a different spectral waveband being assigned to each of said groups;
a central office transmitter provided at said central office, comprising:
point-to-point encoding means for encoding point-to-point signals using optical point-to-point codes, different optical point-to-point codes within a same corresponding waveband being associated to the user terminals of a same, group;
broadcast encoding moans for encoding copies of the broadcast signal using single wavelength channels within the corresponding waveband of each group, a single wavelength channel being associated with all the user terminals of a same group; and
transmitting means for transmitting the point-to-point signals and copies of the broadcast signal in all wavebands from the central office to the user terminals through the optical network; and
a user receiver provided at each user terminal for receiving from the optical network the point-to-point signals and copies of the broadcast signal, each user receiver comprising:
point-to-point decoding means for decoding point-to-point signals encoded using an optical point-to-point code associated with the corresponding user terminal; and
broadcast decoding moans for decoding the broadcast signal decodable using the single wavelength channel associated with the user terminals of the corresponding group of user terminals.

10. The optical communications system according to claim 9, wherein the point-to-point codes are OCDM codes.

11. The optical communications system according to claim 10, wherein waveband is divided into a first and a second sub-waveband, the point-to-point codes of each waveband being included in the fist sub-waveband thereof, and the corresponding single wavelength channel being included into the second sub-waveband.

12. The optical communications system according to claim 9, wherein each group of user terminals includes between 2 and 30 user terminals.

13. The optical communications system according to claim 9, wherein each waveband has a spectral width between 0.4 and 8 nm.

14. The optical communications system according to claim 9, wherein the point-to-point encoding means include a plurality of encoders associated with each user terminals, each of said encoders including a plurality of fiber Bragg gratings.

15. The optical communications system according to claim 9, wherein the broadcast encoding means includes a plurality of encoders associated with each of said user groups, each of said encoders including a plurality of fiber Bragg gratings.

16. The optical communications system according to claim 9, wherein the transmitting means comprises:
a central office multiplexer for multiplexing the point-to-point and broadcast signals into a multiplexed signal transmitted through said optical network;
a group de-multiplexer positioned in a vicinity of the user terminals for de-multiplexing said multiplexed signal according to said wavebands, each of said wavebands being transmitted to the corresponding group of users; and
a terminal splitter positioned in a vicinity of said user terminals of each group for splitting the corresponding waveband into fractions thereof transmitted to each user terminals of said group.

17. The combination of an optical communications system according to claim 9 with the optical network, said optical network being fiber-based.
